(19) United States
(12) Patent Application Publication
(10) Pub. No.: US 2015/0146234 A1
(43) Pub. Date: May 28, 2015

(54) IMAGE FORMING DEVICE, IMAGE FORMING SYSTEM AND IMAGE FORMING METHOD

(71) Applicant: Konica Minolta Inc., Tokyo (JP)

(72) Inventor: Shigeo KONUMA, Tokyo (JP)

(73) Assignee: KONICA MINOLTA INC., Tokyo (JP)

(21) Appl. No.: 14/546,831

(22) Filed: Nov. 18, 2014

(30) Foreign Application Priority Data
Nov. 26, 2013 (JP) 2013-243812

(51) Int. Cl. H04N 1/00; G06K 15/02; H04N 1/21; G06K 15/00

(52) U.S. Cl. CPC H04N 1/00771; G06K 15/005; G06K 15/021; H04N 1/2166; G06K 15/408; G06K 15/4065; H04N 2201/0094
USPC 358/1.14

(57) ABSTRACT

An image forming device includes: an image forming unit configured to form an image based on a job including image data and ticket information; a storage unit configured to store a stored job; an operation display unit configured to be operated and display; and a control unit configured to control at least the storage unit and the operation display unit, wherein, when the job is selected from the stored jobs stored in the storage unit, the control unit compares contents of current machine setting with the ticket information of the selected job and displays function display for changing the machine setting on the operation display unit together with warning when the ticket information includes setting which makes output with the contents of the current machine setting impossible.

The entire disclosure of Japanese Patent Application No. 2013-243812 filed on Nov. 26, 2013 including description, claims, drawings, and abstract are incorporated herein by reference in its entirety.

### BACKGROUND OF THE INVENTION

1. Field of the Invention

The present invention relates to an image forming device which forms an image based on a job including image data and ticket information, an image forming system, and an image forming method.

2. Description of the Related Art

An image forming device which forms an image on paper forms the image based on a job including image data and ticket information. The job may be temporarily stored in a storage unit such as an image memory and a HDD as a stored job and the jobs are executed in a predetermined order out of the stored jobs according to a schedule screen and the like.

The stored jobs may be displayed in a list on an operation display unit and it is possible to select a desired job from the list to edit the ticket information of the selected job, delete the job, and make a reservation as an execution job.

The image forming device (for example, refer to JP 2013-88733 A) and the like capable of changing machine setting of the image forming device even after the job the ticket information of which is set is stored, for example, capable of changing setting of a tray to feed the paper or changing a system configuration through unit exchange is proposed.

For example, as the image forming device according to JP 2013-88733 A, an image forming device capable of changing a system configuration through unit exchange, the image forming device including a job registering unit capable of registering a reservation of a single job including a page in which a printing condition corresponding to a first system configuration is set and a page in which a printing condition corresponding to a second system configuration is set, a printing unit configured to print based on the job the reservation of which is registered by the job registering unit, and a control unit configured to extract a page which may be printed with a current system configuration of the image forming device out of the pages included in the job the reservation of which is registered by the job registering unit and allow the printing unit to print is proposed.

However, the image forming device according to JP 2013-88733 A has a configuration to extract only the page which may be output with a current machine state to output from the job the reservation of which is registered (state in which the job is selected and an output reservation thereof is determined) and is characterized in outputting a part which may be output of the job a condition of which is mismatched so as not to stop the machine. There also is a configuration to display output availability on the schedule screen in a state in which the job is put on a reserved job list.

However, in a case in which the job is selected from the stored jobs, unlike a case in which the reserved job is executed based on the schedule screen, a user cannot determine whether this maybe directly output with current machine setting state regardless of whether this is made the reserved job to be output. This is because the user is not notified of the output availability when the stored job is merely selected but notified of this when the job is made the reserved job.

When the setting must be changed, it is not possible to figure out what to do in advance. Therefore, there is a problem that change work of the setting cannot be performed until an output turn of the job comes.

### SUMMARY OF THE INVENTION

The invention of the present application is achieved in view of the above-described circumstances and an object thereof is to provide an image forming device, an image forming system, and an image forming method enabling a user to determine whether a selected stored job maybe directly output with a current machine setting state.

That is to say, to achieve at least one of the above-mentioned objects, according to an aspect, an image forming device reflecting one aspect of the present invention comprises: an image forming unit configured to form an image based on a job including image data and ticket information; a storage unit configured to store a stored job; an operation display unit configured to be operated and display; and a control unit configured to control at least the storage unit and the operation display unit, wherein, when the job is selected from stored jobs stored in the storage unit, the control unit compares contents of current machine setting with the ticket information of the selected job and displays function display for changing the machine setting on the operation display unit together with warning when the ticket information includes setting which makes output with the contents of the current machine setting impossible.

In the image forming device reflecting one aspect of the present invention according to Item. 1, the control unit preferably has a function to display a list of the stored jobs on the operation display unit and displays, when the selected job includes the setting which makes the output with the contents of the current machine setting impossible, display regarding the job in a display format different from a normal display format.

In the image forming device reflecting one of the present invention according to Item. 2, an item displayed in the display format different from the normal display format is preferably an item of the ticket information different from the current machine setting.

In the image forming device reflecting one aspect of the present invention according to any one of Items. 1 to 3, the control unit preferably displays the function display for changing the machine setting on the operation display unit in a position not overlapped with display of contents of the list of the stored jobs and contents of the ticket information of the stored job.

In the image forming device reflecting one aspect of the present invention according to any one of Items. 1 to 4, the machine setting preferably includes setting regarding paper.

In the image forming device reflecting one aspect of the present invention according to Item. 5, the control unit preferably displays a tray setting state on the operation display unit as the contents of the current machine setting, the tray setting state at least including display of a paper size, a paper name, and basis weight, and a condition to determine difference in the setting further includes adjustment values accompanying with a profile of the paper.

The image forming device reflecting one aspect of the present invention according to Item. 5 or 6 is preferably configured to display when the ticket information of the selected job includes the setting which makes the output with contents of setting of a currently used tray impossible, information to distinguish whether the same tray is scheduled to be used by another stored job.

To achieve at least one of the above-mentioned objects, according to an aspect, an image forming system reflecting one aspect of the present invention comprises: an image forming unit configured to form an image based on a job including image data and ticket information; a storage unit configured to store a stored job; an operation display unit configured to be operated and display; and a control unit configured to control at least the storage unit and the operation display unit, wherein, when the job is selected from stored jobs stored in the storage unit, the control unit compares contents of current machine setting with the ticket information of the selected job and displays function display for changing the machine setting on the operation display unit together with warning when the ticket information includes setting which makes output with the contents of the current machine setting impossible.

In the image forming system reflecting one aspect of the present invention according to Item. 8, the control unit preferably has a function to display a list of the stored jobs on the operation display unit and displays, when the selected job includes the setting which makes the output with the contents of the current machine setting impossible, display regarding the job in a display format different from a normal display format.

In the image forming system reflecting one aspect of the present invention according to Item. 8 or 9, an item displayed in the display format different from the normal display format is preferably an item of the ticket information different from the current machine setting.

In the image forming system reflecting one aspect of the present invention according to any one of Items. 8 to 10, the control unit preferably displays the function display for changing the machine setting on the operation display unit in a position not overlapped with description of contents of the list of the stored jobs and contents of the ticket information of the stored job.

In the image forming system reflecting one aspect of the present invention according to any one of Items. 8 to 11, the machine setting preferably includes setting regarding paper.

In the image forming system reflecting one aspect of the present invention according to the Item. 12, the control unit preferably displays a tray setting state on the operation display unit as the contents of the current machine setting, the tray setting state at least including display of a paper size, a paper name, and basis weight, and a condition to determine difference in the setting further includes adjustment values accompanying with a profile of the paper.

The image forming system reflecting one aspect of the present invention according to Item. 12 or 13 is preferably configured to display, when the ticket information of the selected job includes setting which makes the output with contents of setting of a currently used tray impossible, information to distinguish whether the same tray is scheduled to be used by another stored job.

To achieve at least one of the above-mentioned objects, according to an aspect, an image forming method reflecting one aspect of the present invention of storing a job including image data and ticket information in a storage unit and forming an image based on the job comprises: when the job is selected from stored jobs stored in the storage unit, comparing contents of current machine setting with the ticket information of the selected job and enabling operation for changing the machine setting together with warning when the ticket information includes setting which makes output with the contents of the current machine setting impossible.

The image forming method reflecting one aspect of the present invention according to the Item. 15 having a function to display a list of the stored jobs, preferably includes: displaying, when the selected job includes the setting which makes the output with the contents of the current machine setting impossible, display regarding the job in a display format different from a normal display format.

In the image forming method reflecting one aspect of the present invention according to Item. 15 or 16, an item displayed in the display format different from the normal display format is preferably an item of the ticket information different from the current machine setting.

The image forming method reflecting one aspect of the present invention according to any one of Items. 15 to 17, preferably includes: displaying the function display for changing the machine setting in a position not overlapped with description of contents of the list of the stored jobs and contents of the ticket information of the stored job.

In the image forming method reflecting one aspect of the present invention according to any one of Items. 15 to 18, the machine setting preferably includes setting regarding paper.

The image forming method reflecting one aspect of the present invention according to Item. 19, preferably includes: displaying a tray setting state as the contents of the current machine setting, the tray setting state at least including display of a paper size, a paper name, and basis weight, wherein a condition to determine difference in the setting further includes adjustment values accompanying with a profile of the paper.

The image forming method reflecting one aspect of the present invention according to Item. 19 or 20, preferably includes: displaying, when the ticket information of the selected job includes setting which makes the output with contents of setting of a currently used tray impossible, information to distinguish whether the same tray is scheduled to be used by another stored job.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a schematic diagram illustrating a mechanical configuration of an image forming system according to an embodiment of the present invention;

FIG. 2 is a view of a control block of the image forming system including an image forming device according to an embodiment of the present invention;

FIG. 3 is a view of a configuration example of a screen on which a list of stored jobs is displayed illustrating a screen to notify that it is possible to output when a job is selected according to an embodiment of the present invention;

FIG. 4 is a view of a configuration example of the screen on which the list of the stored jobs is displayed illustrating a screen example on which a tray setting state of a machine is displayed and a button for changing paper setting of the machine is displayed when it is not possible to output with current machine setting according to an embodiment of the present invention;

FIG. 5 is a view of an example of a machine paper setting change screen according to an embodiment of the present invention; and

FIG. 6 is a flowchart illustrating a display procedure when the job is selected on the screen of the list of the stored jobs according to an embodiment of the present invention.

### DESCRIPTION OF THE PREFERRED EMBODIMENTS

Hereinafter, an embodiment of the present invention will be described with reference to the drawings. However, the scope of the invention is not limited to the illustrated examples.

An image forming system according to an embodiment of the present invention is hereinafter described with reference to the attached drawings.

The image forming system is configured such that a large-capacity paper feed tray 171 is connected on a preceding stage of an image forming device 1 and a post-processing device (FNS) 180 is connected on a subsequent stage of the image forming device 1. In the image forming system, paper may be conveyed between devices and the devices may communicate with each other. Meanwhile, although the image forming system is formed of the image forming device 1, the post-processing device (FNS) 180 and the like in this embodiment, the post-processing device and the like may also be included in the image forming device.

The image forming device 1 is provided with a scanner unit 130 including a CCD 131 and a flow-type automatic document feeder (ADF) 135 on an upper side thereof such that an image of a document may be read through platen glass or ADF document reading slit glass.

The above-described scanner unit 130, flow-type automatic document feeder (ADF) 135, platen glass, ADF document reading slit glass form an image reading unit.

An operation unit 140 is provided in a place in which the platen glass is not located on the upper side of the image forming device 1. The operation unit 140 includes a touch panel LCD 140A with which touch panel operation may be performed and is further provided with an input port such as a mouse 140C or a USB mouse on a side of the touch panel LCD 140A.

The operation unit 140 may be operated by an operator, and the touch panel LCD 140A on which various pieces of information may be displayed further has a configuration as a display unit. That is to say, the touch panel LCD 140A and the mouse 140C correspond to an operation display unit of the present invention as the operation unit 140.

As described above, in this embodiment, the operation display unit may be formed of the operation unit which is operated and a display unit which displays; the operation unit and the display unit may be separately formed or integrally formed.

Meanwhile, in the present invention, the operation unit may set a function, an execution condition and the like of the image forming device such as a copier and a printer and the display may be formed of the display unit formed of a CRT, liquid crystal, or EL display panel. The operation display unit may be provided with the touch panel which detects a coordinate position corresponding to a button position of the display panel and may include an input device such as the mouse.

A plurality of paper feed trays (1 to 3) 170 (three tiers in the drawing) is arranged on a lower side of the image forming device 1 and the large-capacity paper feed tray 171 including the paper feed tray is further arranged so as to be attached to the image forming device 1.

A conveyance path through which the paper fed from any one of the paper feed trays is conveyed, a paper feed roller and the like are provided in the image forming device 1, and an image forming unit formed of a charger 154, an LD 152, a photoreceptor 153, a developer 155, a transfer unit 156, a fixer 157 and the like is provided in the middle of the conveyance path in the image forming device 1. A conveyance path (not illustrated) which conveys the fed paper to guide into the image forming device 1 is provided in the large-capacity paper feed tray 171. Furthermore, the post-processing device (FNS) 180 includes a paper ejection path for conveying the paper on which an image is printed to eject without performing the post-processing or after performing the post-processing.

A printer unit 150 is formed of the above-described image forming unit, paper feed trays (1-3) 170, large-capacity paper feed tray 171, conveyance path, paper feed roller and the like.

In the image forming unit, the charger 154, the developer 155, and the transfer unit 156 are arranged around the photoreceptor 153. The charger 154 uniformly charges a surface of the photoreceptor 153 before the image is written. The LD 152 irradiates the photoreceptor 153 the surface of which is uniformly charged with semiconductor laser, thereby forming an electrostatic latent image on the photoreceptor 153. The developer 155 develops the electrostatic latent image formed by the LD 152 on the photoreceptor 153 with a toner member. A toner image is formed on the photoreceptor 153 by this developing process. The transfer unit 156 transfers the toner image on the photoreceptor 153 to the paper conveyed from the paper feed trays (1-3) 170 and the large-capacity paper feed tray 171. The paper to which the toner image is transferred is separated from the photoreceptor 153 to be conveyed to the fixer 157. The toner member remained on the photoreceptor 153 is removed by a cleaning unit.

The fixer 157 fixes the toner image transferred on a front surface side of the paper by heating the conveyed paper. The paper to which a fixing process is applied is directly conveyed to the post-processing device (FNS) 180 located on the side of the image forming device 1 in a case of single-side printing. The paper after the fixing is switched back and a predetermined image is transferred on a rear surface side of the paper by the image forming unit in a case of both-side printing. The paper on both sides of which the images are formed is conveyed to the post-processing device (FNS) 180 after the fixing.

The post-processing device (FNS) 180 performs post-processing such as stapling, punching, and center folding and ejects the paper.

Although the above-described image forming system includes the image forming device 1, the large-capacity paper feed tray 171, the post-processing device (FNS) 180, and a terminal (PC) 3 to be described later, a device forming the image forming system is not especially limited as the present invention and the number and type of devices other than the image forming device are not especially limited; the system may be provided with a plurality of post-processing devices, and various external devices such as a relay device and a stacking device may be connected thereto besides them.

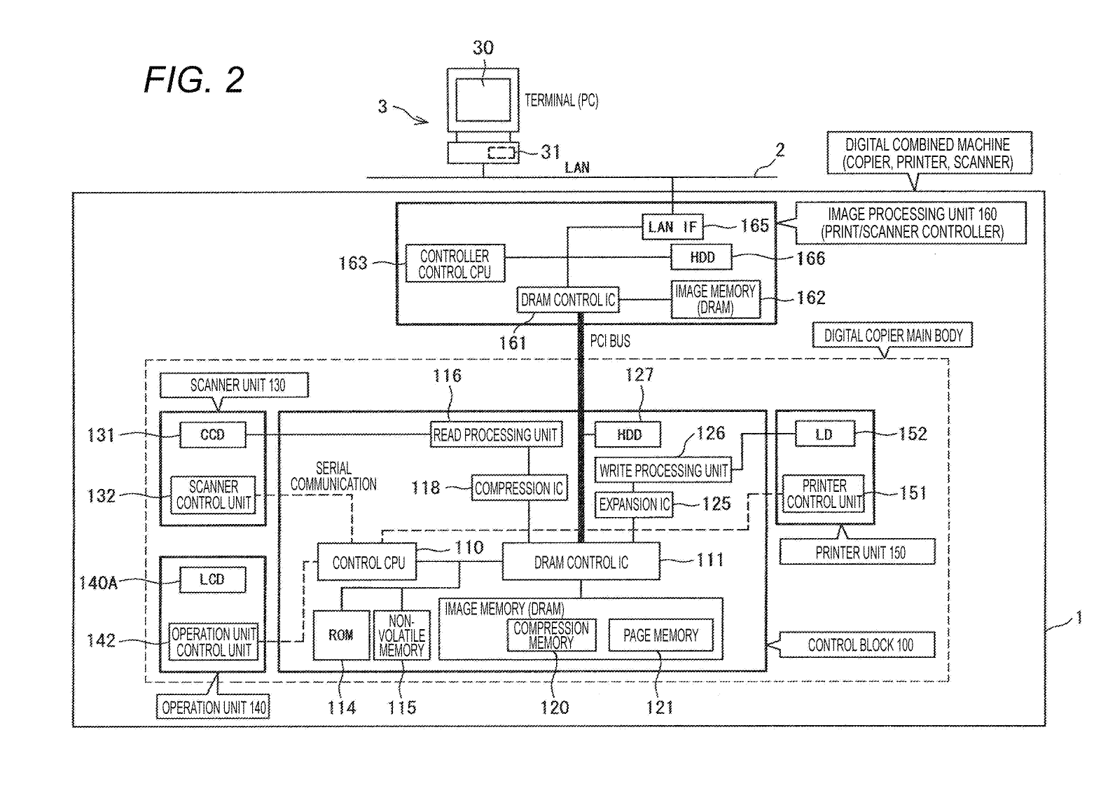

FIG. 2 is a view illustrating a control block of the image forming system of this embodiment.

The image forming system is provided with the image forming device 1 and the terminal (PC) 3 and they are connected by a LAN 2 being a network such that they may communicate with each other. The terminal (PC) 3 may remotely operate the image forming device 1. Meanwhile, in this drawing, control blocks of the post-processing device (FNS) 180 and the large-capacity paper feed tray 171 are not illustrated.

Meanwhile, the image forming system may be configured such that a plurality of image forming devices is connected by the LAN 2 or that another image forming device is connected as a terminal in place of the terminal (PC) 3 such that remote operation may be performed.

The image forming device 1 includes a control block 100, the scanner unit 130, the operation unit 140, and the printer unit 150 as a main configuration.

The control block 100 is provided with a control CPU 110 and a DRAM control IC 111 is connected to the control CPU 110. A ROM 114 and a non-volatile memory 115 are connected to the control CPU 110. A program and the like which operates the control CPU 110 is stored in the ROM 114. The non-volatile memory 115 is formed of a flash memory and the like in which initial print setting information of the image forming device 1, machine setting information such as a process control parameter, initial data of output setting, information of a screen displayed on the operation unit, machine setting and the like are stored.

The control CPU 110 may read non-volatile data in the non-volatile memory 115 and may write desired data in the non-volatile memory 115.

The control CPU 110 controls operation of each unit of the image forming device 1 according to the above-described machine setting information, print setting information, output setting and the like.

The control CPU 110 forms a control unit of the present invention together with the ROM 114, the non-volatile memory 115 and the like and controls the image forming device and the image forming system to figure out a state of the image forming device.

The scanner unit 130 is provided with the CCD 131 which optically reads and a scanner control unit 132 which controls an entire scanner unit 130. The scanner control unit 132 is connected to the control CPU 110 to be controlled by the control CPU 110. Meanwhile, the scanner control unit 132 may be formed of a CPU, a program which operates the same and the like. A read processing unit 116 performs data processing on information of an image read by the CCD 131. The read processing unit 116 is connected to the DRAM control IC 111 and image data obtained by the data processing by the read processing unit 116 is transmitted to the DRAM control IC 111.

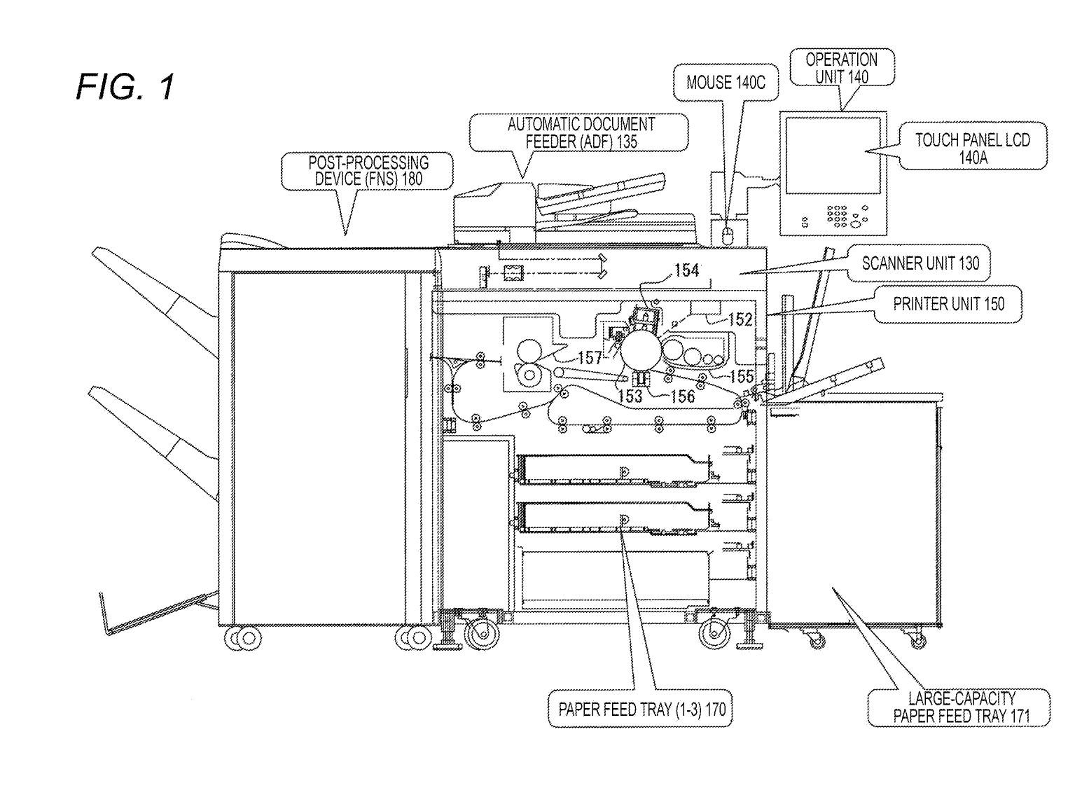

The operation unit 140 is provided with the above-described touch panel LCD 140A, an operation unit control unit 142, and the mouse 140C illustrated in FIG. 1 and may be provided with a VRAM and the like not illustrated. The operation unit control unit 142 is configured to control the touch panel LCD 140A and the mouse 140C and the operation unit control unit 142 and the control CPU 110 are connected to each other such that serial communication may be performed therebetween.

The control CPU 110 may control an entire operation unit 140 by sending a control instruction to the operation unit control unit 142. The operation unit control unit 142 obtains an operation input coordinate by the touch panel LCD 140A and the mouse 140C and transmits the same to the control CPU 110.

That is to say, the operation unit 140 is a device including the display unit of CRT, liquid crystal, EL and the like and the input unit such as the touch panel which detects the coordinate position corresponding to the button position of the display unit and the mouse.

According to the above-described configuration, the operation unit 140 is controlled by the control CPU 110, and an operation screen drawn in the VRAM is displayed on the touch panel LCD 140A and input information of the operation unit 140 is transmitted to the control CPU 110. Meanwhile, the operation unit control unit 142 maybe formed of a CPU, a program which operates the same and the like. Information of the screen drawn in the VRAM may be stored in the non-volatile memory 115 and the HDD 127 to be read as necessary.

The control CPU 110 may draw an operation screen displayed on the terminal (PC) 3 for the remote operation in the VRAM and transmit a screen image to the terminal (PC) 3 to display a terminal operation screen on a terminal operation unit 30 so as to be operated. In this case, the terminal operation unit 30 may serve as the operation display unit of the present invention.

A compression IC 118 which compresses the image data and an expansion IC 125 which expands the image data are connected to the DRAM control IC 111. An image memory (DRAM) including a compression memory 120 and a page memory 121 is further connected to the DRAM control IC 111 and the HDD 127 is further connected thereto through a PCI bus.

A stored job and a reserved job may be stored in the compression memory 120 of the image memory (DRAM) and the HDD 127 and they form a storage unit of the present invention. The job includes the image data and ticket information. The ticket information includes a paper size, a paper type, color, finishing processing option, a job ticket number, a job title and the like. Meanwhile, contents of the ticket information are not limited to those herein defined.

The DRAM control IC 111 controls compression processing of the image data by the compression IC 118 and expansion processing of compressed image data by the expansion IC 125 and controls input/output of the image data to/from the image memory (DRAM) and the HDD 127 according to an instruction from the control CPU 110.

A write processing unit 126 is connected to the LD 152 of the printer unit 150 to generate write data used in operation of the LD 152 based on the image data.

The printer unit 150 is formed of the image forming unit, the paper feed trays (1 to 3) 170, the conveyance path and the like.

The printer unit 150 is provided with a printer control unit 151 which controls an entire printer unit 150 (paper feeding, image formation, paper ejection, post-processing and the like) and the printer control unit 151 is connected to the above-described control CPU 110 such that they may serially communicate with each other. The printer control unit 151 operates according to the control instruction of the control CPU 110 and controls the printer unit 150 to convey the paper and form the image.

A DRAM control IC 161 of an image processing unit (print/scanner controller) 160 is connected to the PCI bus to which the DRAM control IC 111 is connected as described above. The image processing unit (print/scanner controller) 160 is configured to receive the image data and the like from the terminal (PC) 3 connected to the LAN 2 by the image forming device 1 and transmit the image data obtained by the scanner unit 130 to the terminal (PC) 3 connected to the LAN 2 when the image forming device 1 is used as a network printer or a network scanner.

An image memory 162 formed of the DRAM and the like is connected to the DRAM control IC 161 in the image processing unit (print/scanner controller) 160. A controller control unit 163 which controls an entire image processing unit (print/scanner controller) 160, a LAN interface 165, and a HDD 166 are connected to a common bus in the image processing unit (print/scanner controller) 160. The LAN interface 165 is connected to the LAN 2.

The terminal (PC) 3 includes the terminal operation unit 30 which displays the screen and accepts the operation and the terminal operation unit 30 may serve as the operation display unit of the present invention. The terminal (PC) 3 may be configured such that the operation regarding the image forming device 1 may be input on the terminal operation unit 30 through a VNC client and the like or this may operate the image forming device and display as the operation display unit. The terminal operation unit 30 may be formed of the touch panel, for example; however, the unit is not limited to this and it is also possible that an operation unit such as an LCD and an input unit such as a mouse are separately formed. The terminal (PC) 3 may be provided with a terminal control unit 31 to control an entire terminal (PC) 3.

Basic operation of the above-described image forming system is next described.

First, a procedure for accumulating the image data in the image forming device 1 is described.

A case in which the scanner unit 130 reads the image to generate the image data in the image forming device 1 is described. In the scanner unit 130, the CCD 131 optically reads the image from the document. At that time, operation of the CCD 131 is controlled by the scanner control unit 132 which receives the instruction from the control CPU 110. It is possible to read the document while automatically feeding the document by the automatic document feeder (ADF) 135 or putting the document on the platen glass.

The control CPU 110 is operated by the program to issue the instruction to the scanner unit 130 based on the operation (reading instruction and copying instruction) by the operation unit 140. The image read by the CCD 131 is subjected to the data processing by the read processing unit 116 and the image data obtained by the data processing is transmitted to the compression IC 118 to be compressed by a predetermined method. The compressed data is stored in the compression memory 120 of the image memory (DRAM) through the DRAM control IC 111. When this is stored in the HDD 127, the data temporarily stored in the compression memory 120 is transmitted to the HDD 127 through the DRAM control IC 111.

In addition to this, the image data is sometimes input to the image forming device 1 through the LAN 2. The above-described image data includes the data generated by an application program and the like of the terminal (PC) 3 and the like, for example. A method of generating the image data is not especially limited.

The image data input through the LAN 2 is received by the image processing unit (print/scanner controller) 160 through the LAN 2 and the LAN interface 165 to be temporarily stored in the image memory 162 or the HDD 166. The data stored in the image memory 162 or the HDD 166 is subjected to the data processing when necessary and transferred to the DRAM control IC 111 through the PCI bus to be temporarily stored in the page memory 121. The data stored in the page memory 121 is transmitted to the compression IC 118 through the DRAM control IC 111 to be subjected to the compression processing and stored in the compression memory 120 through the DRAM control IC 111. When this is stored in the HDD 127, the data temporarily stored in the compression memory 120 is transmitted to the HDD 127 through the DRAM control IC 111.

When accumulating the above-described image data, it is possible to set the ticket information before or after accumulating the image data. It is possible that a setting screen to which the operation may be input is displayed on the operation unit 140 and the operator inputs the operation to set the ticket information. When an output setting item is selected in initial setting and the setting is not input by the operator also, the ticket information is set by the initial setting. At the time of the remote operation, it is possible to input the setting by using the terminal operation unit 30 of the terminal (PC) 3.

When the image is output by the image forming device 1, that is to say, when this is used as the copier or the printer, the image data stored in the compression memory 120 is transmitted to the expansion IC 125 through the DRAM control IC 111 to be expanded, the expanded data is transmitted to the write processing unit 126, and the LD 152 writes on the photoreceptor 153 charged by the charger 154 according to the write data transmitted from the write processing unit 126.

Meanwhile, when the image data stored in the HDD 127 is used, the image data stored in the HDD 127 is temporarily stored in the compression memory 120 through the DRAM control IC 111, the image data stored in the compression memory 120 is transmitted to the expansion IC 125 through the DRAM control IC 111 to be expanded, and the expanded data is transmitted to the write processing unit 126 in the above-described manner.

In the printer unit 150, each unit is controlled by the printer control unit 151 which receives the instruction of the control CPU 110. In the image forming unit, the latent image written on the photoreceptor 153 is developed as the toner image by the developer 155, the toner image is transferred to the paper supplied through the conveyance path by the transfer unit 156 to be fixed by the fixer 157. On the photoreceptor 153, after the toner image is transferred to the paper, the remained toner is removed by the cleaning unit.

Meanwhile, although the embodiment is described based on the formation of a black-and-white image, a main body of the image forming device may be provided with the photoreceptors and the like for respective colors (for example, cyan, magenta, yellow, and black).

The paper on which the image is formed is conveyed to the post-processing device (FNS) 180 through the conveyance path to be ejected after predetermined post-processing when the post-processing is set or directly ejected when the post-processing is not set.

The terminal (PC) 3 may remotely operate the image forming device 1 as described above. VNC is described as an example; the image forming device 1 is provided with a VNC (TM, the same shall apply hereinafter) server and the terminal (PC) 3 is provided with the VNC client. The control CPU 110 and the like may be used as the VNC server.

The VNC client has a function to obtain screen data from the VNC server of the image forming device 1, pass the same to its own operation unit control unit and display an obtained screen on the terminal operation unit 30, and accept the operation to the screen to transmit to the VNC server of the image forming device 1.

Meanwhile, when the VNC server is notified by the connected VNC client of the remote operation, this draws the display screen for the remote operation in the VRAM by a graphic driver and the like and transmits the screen data drawn in the VRAM to the VNC client. Thereafter, the VNC server accepts operation information from the VNC client and transmits the operation information to the control CPU 110. The control CPU 110 executes the control according to contents of the operation on the terminal operation unit 30. According to this, the remote operation from the terminal operation screen displayed on the terminal operation unit 30 of the terminal (PC) 3 to the image forming device 1 becomes possible.

Meanwhile, the control CPU 110 displays a list of the stored jobs and reserved jobs to be executed on the touch panel LCD 140A such that selecting operation maybe performed. The job may be selected from the stored jobs to be added to the reserved jobs to be executed, the ticket information thereof may be edited, or the job may be deleted. The list of the reserved jobs to be executed may be displayed on a schedule screen in which the order of execution is determined.

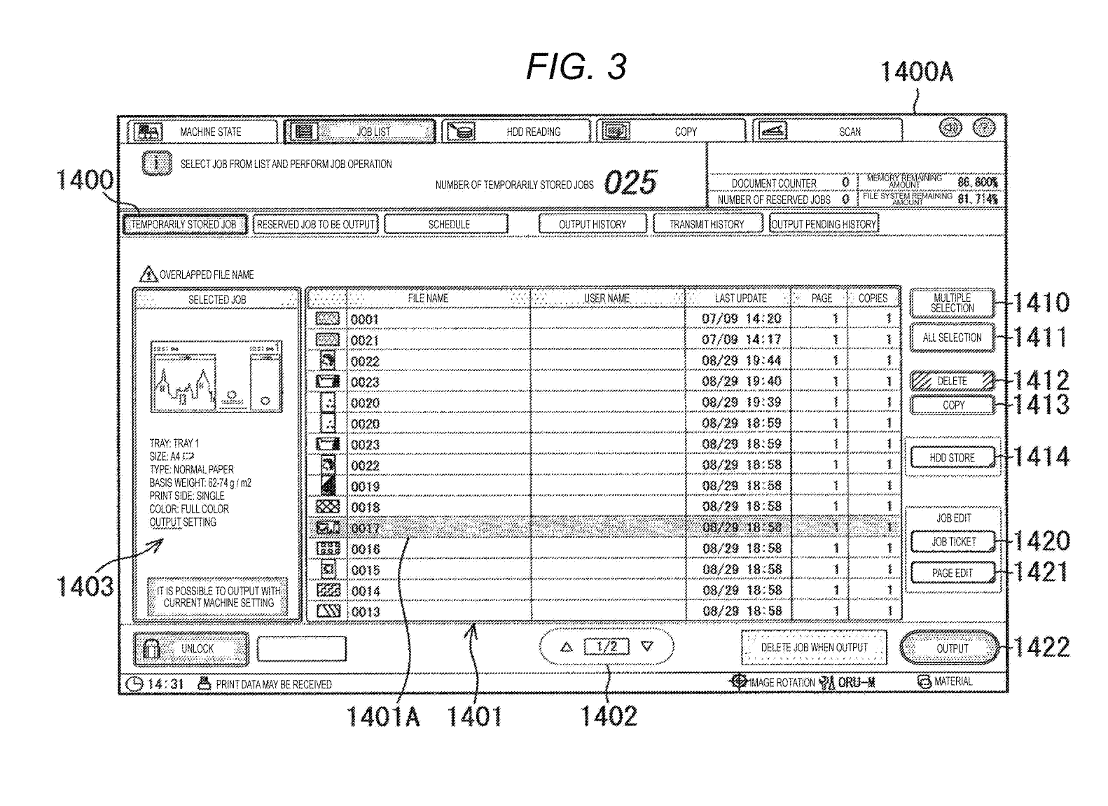

FIG. 3 illustrates a stored job screen 1400A illustrating the list of the stored jobs displayed on the touch panel 140A. The stored job screen 1400A is displayed when a temporarily stored job tag 1400 on the screen is selected.

On the stored job screen 1400A, a job list 1401 in which respective jobs are displayed is displayed and each job maybe selected when a row of the job is pressed. The selected job may be easily distinguished by changed display such as changed background color.

When not all the jobs cannot be displayed in the job list 1401, it is possible to switch a page by pressing a page flip button 1402. When switching the page, it is possible to scroll rows one by one or change the display in a page unit.

Information of the selected job is displayed in a job display field 1403 on a left side of the job list 1401. In the job display field 1403, a preview screen of the image, a selected tray, the paper size, the paper type, basis weight, a print side, a color type and the like are displayed and it is further displayed that it is possible to output with current machine setting.

On the stored job screen 1400A, a multiple selection button 1410 enabling selection of a plurality of jobs and an all selection button 1411 to select all the jobs are included on a right side of the screen, and it becomes possible to select a plurality of jobs or all the jobs by pressing the buttons.

A delete button 1412 and a copy button 1413 are provided below the multiple selection button 1410 and the all selection button 1411 such that they may be pressed. It is possible to delete the selected stored job by pressing the delete button 1412 and it is possible to create the job having the same contents as those of the selected stored jobs to add to the stored job by pressing the copy button 1413. A HDD store button 1414 is provided below them. The HDD store button 1414 may store the job stored in the image memory (DRAM) in the HDD 127.

A job edit field is provided below the HDD store button 1414 in which a job ticket button 1420 and a page edit button 1421 are displayed such that they may be pressed. It is possible to edit job information by pressing the job ticket button 1420. When the page edit button 1421 is pressed, the setting may be changed in the page unit.

An output button 1422 is provided on a lower side of the stored job screen 1400A such that this may be pressed and it is possible to add the selected job to the reserved jobs to be executed. At that time, it is possible to display the list of the reserved jobs to be executed such that the order of outputting and the like may be set.

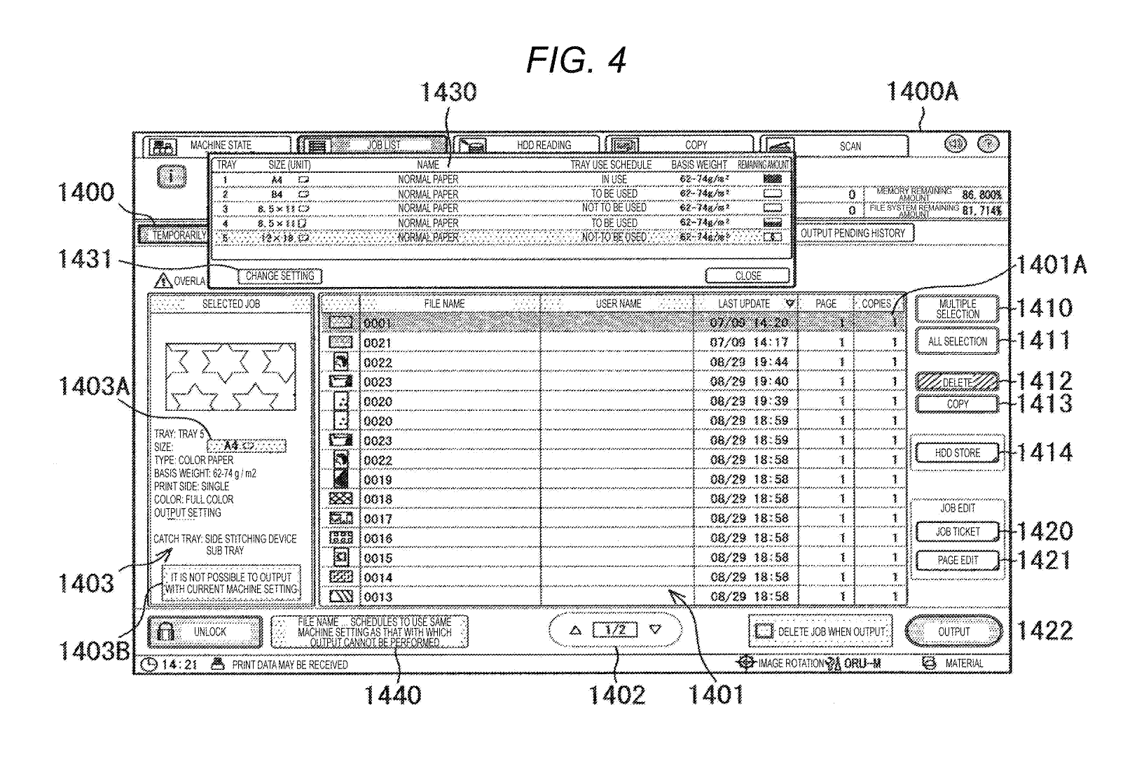

Meanwhile, although a case in which the selected stored job may be output with the current machine setting is described in the above-described stored job screen 1400A, a case in which the selected stored job cannot be output with the current machine setting is described based on the stored job screen 1400A in FIG. 4. Meanwhile, the same reference sign is assigned to the same configuration as that in the screen in FIG. 3 and the description thereof is omitted or simplified.

When the selected stored job cannot be output with the current machine setting, an item of the ticket information different from the current machine setting is displayed in a display format different from that of normal display in the job display field 1403. In this example, in tray setting as information regarding the paper, the paper size being an item of the ticket information is set to an A4-size, and the current machine setting is the tray setting to use paper measuring 12 by 18 inches, so that it is not possible to output; paper size display 1403A in the job display field 1403 is highlighted so as to be different from other display. Meanwhile, in the ticket information, the paper type is color paper and is different from normal paper of the current machine setting, this difference does not make it impossible to output, so that a display format is not especially changed.

In the job display field 1403 of the stored job screen 1400A, warning display 1403B warning that it is not possible to output with the current machine setting is displayed. Meanwhile, a method of displaying the warning is not especially limited in the present invention; this may be displayed using any but the operation unit 140 or sound notification and the like is also possible.

Further, on the stored job screen 1400A, when the selected stored job cannot be output with the current machine setting, tray setting display 1430 displaying contents of the tray setting of the corresponding machine setting is displayed on the stored job screen 1400A.

The tray setting display 1430 is displayed in a position not overlapped with display of contents of the list of the stored jobs and contents of the ticket information of the stored job. In the tray setting display 1430, the contents of the tray setting with which the selected stored job cannot be output are displayed in the display format different from that of the contents of another tray setting and the tray setting of a corresponding tray No. 5 is highlighted in this example.

A setting change button 1431 to change the tray setting being the current machine setting is provided in the tray setting display 1430 such that this may be pressed. The setting change button 1431 corresponds to function display for changing the machine setting.

Display of job scheduling to use disabling setting 1440 is provided at the bottom of the stored job screen 1400A. The stored job which schedules to use the machine setting with which the selected stored job cannot be output is displayed in the display of job scheduling to use disabling setting 1440 such that it is possible to distinguish whether there is the reserved job which uses the machine setting with which the output cannot be performed.

Meanwhile, the above-described display for distinguishing may be displayed in any place of the screen and is not especially limited in this embodiment.

It is possible to easily distinguish by the above-described distinguish display whether there is a failure when the current machine setting is changed.

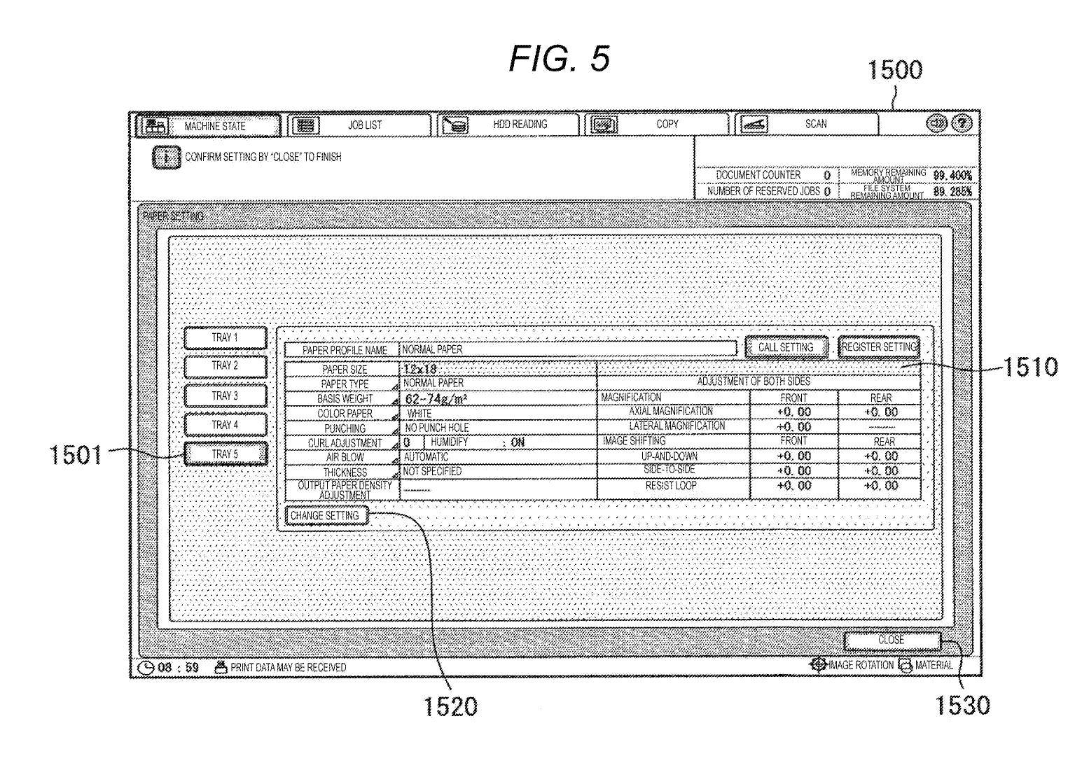

FIG. 5 illustrates a tray setting screen 1500 displayed when the setting change button 1431 is pressed. In FIG. 4, the tray No. 5 is in the machine setting with which the selected stored job cannot be output, so that the tray setting screen 1500 corresponding to the tray No. 5 is displayed when the setting change button 1431 is pressed. On the tray setting screen 1500, it is displayed that this is a setting item regarding the tray No. 5.

On the tray setting screen 1500, adjustment values accompanying with a paper profile such as the paper size, the paper type (paper name), the basis weight, color paper, the punching, curl adjustment, air blow, thickness, output paper density adjustment are displayed in setting content display 1510.

Out of them, the paper size is the item of the ticket information which makes it impossible to output, so that this is highlighted so as to be different from other display. It is possible to change mismatch in the setting by changing the item to the A4-size in the ticket information. Meanwhile, if the paper different from A4-size paper is actually stored in the tray No. 5, it is required to change the paper in the tray No. 5 to the A4-size paper such that this conforms to the paper setting in the tray No. 5. Although it is described that the machine setting is changed to eliminate the mismatch in the machine setting in this example, it is possible to edit the job ticket to change such that the machine setting matches. Since the function display for changing the machine setting is displayed on the operation unit 140, it becomes possible to resolve the mismatch in the machine setting by selecting any of or both of the machine setting and the ticket edition by the operator.

From above, it becomes possible to indicate change work of the machine setting on the screen of the stored job before an output turn comes.

After the machine setting, when a setting change button 1520 is pressed, the setting is confirmed, and when a close button 1530 is pressed, the tray setting screen 1500 is closed and the stored job screen 1400A may be displayed again. At that time, the mismatch between the ticket information and the machine setting is resolved, so that the tray setting display 1430 is not displayed on the stored job screen 1400A and it is displayed that it is possible to output with the current machine setting in the job display field 1403. In the job display field 1403, the display of the paper size being the item of the ticket information different form the current machine setting is displayed in the same display format as that of another item.

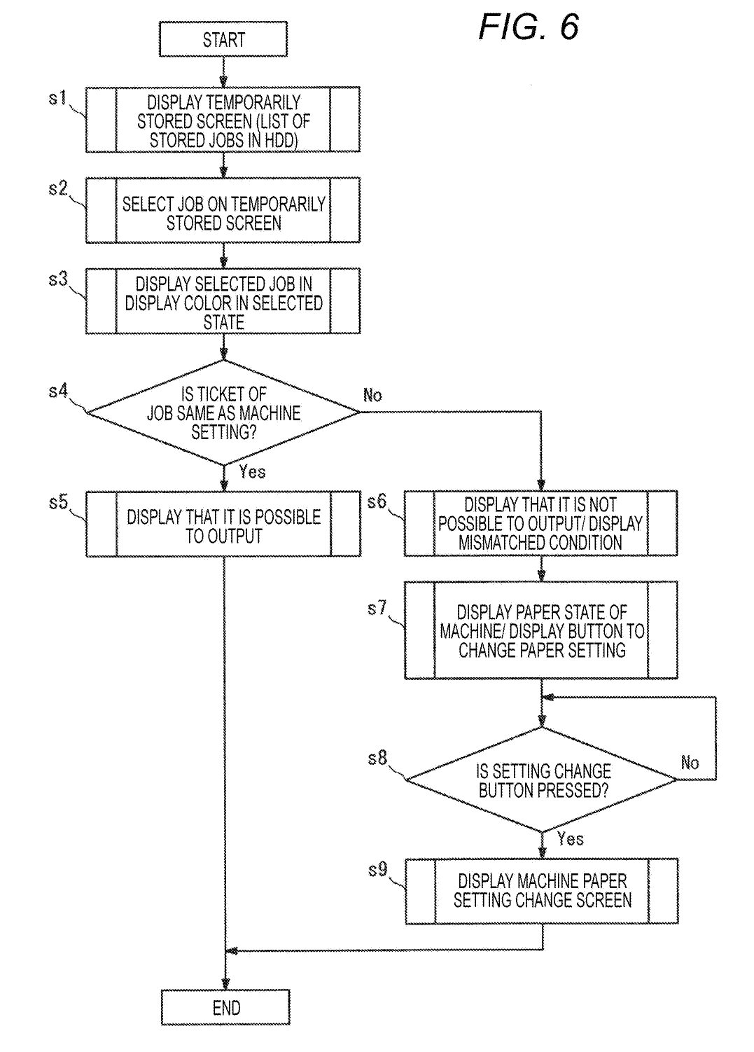

Next, a procedure when the job is selected from the list of the stored jobs is described based on a flowchart in FIG. 6. Meanwhile, the following procedure is executed by the control of the control CPU 110.

First, a temporarily stored screen (list of stored jobs in HDD) is displayed on the operation unit 140 (step s1). Selection of the job by the operator on the temporarily stored screen is accepted (step s2). The selected job is displayed in the list in display color indicating a selected state (step s3).

Next, it is determined whether the ticket information of the selected job is the same as the machine setting (step s4). When the ticket information is the same as the machine setting (Yes at step s4), it is displayed on the operation unit that the output may be performed (step s5), and the procedure is finished.

On the other hand, when the ticket information is different from the machine setting (No at step s4), it is displayed on the operation unit that the output cannot be performed and a mismatched condition is displayed on the operation unit (step s6). Next, a paper state of the machine is displayed and a button to change the paper setting is displayed on the operation unit (step s7). Thereafter, it is determined whether a setting change button is pressed (step s8), it is waited when this is not pressed, (No at step s8), and a machine paper setting change screen is displayed (step s9) when the setting change button is pressed (Yes at step s8), then the setting change is made possible and the procedure is finished.

Although the present invention is described above based on the above-described embodiment, this may be appropriately changed within the scope of the present invention.

As described above, according to an embodiment of the present invention, it is possible to determine whether it is possible to output without changing the setting when the job is selected from the stored jobs, and it becomes possible to improve an operation rate of the machine (not to stop the machine) by user decision. When the job is selected, it is possible to edit the ticket or change paper setting of the machine if the setting is different and it becomes possible to improve the operation rate of the machine (not to stop the machine).

Although the present invention has been described and illustrated in detail, it is clearly understood that the same is by way of illustrated and example only and is not to be taken by way of limitation, the scope of the present invention being interpreted by terms of the appended claims.

What is claimed is:

1. An image forming device comprising:
an image forming unit configured to form an image based on a job including image data and ticket information;
a storage unit configured to store a stored job;
an operation display unit configured to be operated and display; and
a control unit configured to control at least the storage unit and the operation display unit, wherein
when the job is selected from stored jobs stored in the storage unit, the control unit compares contents of current machine setting with the ticket information of the selected job and displays function display for changing the machine setting on the operation display unit together with warning when the ticket information includes setting which makes output with the contents of the current machine setting impossible.

2. The image forming device according to claim 1, wherein the control unit has a function to display a list of the stored jobs on the operation display unit and displays, when the selected job includes the setting which makes the output with the contents of the current machine setting impossible, display regarding the job in a display format different from a normal display format.

3. The image forming device according to claim 2, wherein an item displayed in the display format different from the normal display format is an item of the ticket information different from the current machine setting.

4. The image forming device according to claim 1, wherein the control unit displays the function display for changing the machine setting on the operation display unit in a position not overlapped with display of contents of a list of the stored jobs and contents of the ticket information of the stored job.

5. The image forming device according to claim 1, wherein the machine setting includes setting regarding paper.

6. The image forming device according to claim 5, wherein the control unit displays a tray setting state on the operation display unit as the contents of the current machine setting, the tray setting state at least including display of a paper size, a paper name, and basis weight, and a condition to determine difference in the setting further includes adjustment values accompanying with a profile of the paper.

7. The image forming device according to claim 5, configured to display, when the ticket information of the selected job includes the setting which makes the output with contents of setting of a currently used tray impossible, information to distinguish whether the same tray is scheduled to be used by another stored job.

8. An image forming system comprising:
an image forming unit configured to form an image based on a job including image data and ticket information;
a storage unit configured to store a stored job;
an operation display unit configured to be operated and display; and
a control unit configured to control at least the storage unit and the operation display unit, wherein
when the job is selected from stored jobs stored in the storage unit, the control unit compares contents of current machine setting with the ticket information of the selected job and displays function display for changing the machine setting on the operation display unit together with warning when the ticket information includes setting which makes output with the contents of the current machine setting impossible.

9. The image forming system according to claim 8, wherein the control unit has a function to display a list of the stored jobs on the operation display unit and displays, when the selected job includes the setting which makes the output with the contents of the current machine setting impossible, display regarding the job in a display format different from a normal display format.

10. The image forming system according to claim 9, wherein an item displayed in the display format different from the normal display format is an item of the ticket information different from the current machine setting.

11. The image forming system according to claim 8, wherein the control unit displays the function display for changing the machine setting on the operation display unit in a position not overlapped with description of contents of a list of the stored jobs and contents of the ticket information of the stored job.

12. The image forming system according to claim 8, wherein the machine setting includes setting regarding paper.

13. The image forming system according to claim 12, wherein the control unit displays a tray setting state on the operation display unit as the contents of the current machine setting, the tray setting state at least including display of a paper size, a paper name, and basis weight, and a condition to determine difference in the setting further includes adjustment values accompanying with a profile of the paper.

14. The image forming system according to claim 12, configured to display, when the ticket information of the selected job includes setting which makes the output with contents of setting of a currently used tray impossible, information to distinguish whether the same tray is scheduled to be used by another stored job.

15. An image forming method of storing a job including image data and ticket information in a storage unit and forming an image based on the job, comprising:
when the job is selected from stored jobs stored in the storage unit, comparing contents of current machine setting with the ticket information of the selected job and enabling operation for changing the machine setting together with warning when the ticket information includes setting which makes output with the contents of the current machine setting impossible.

16. The image forming method according to claim 15 having a function to display a list of the stored jobs, comprising:
displaying, when the selected job includes the setting which makes the output with the contents of the current machine setting impossible, display regarding the job in a display format different from a normal display format.

17. The image forming method according to claim 16, wherein an item displayed in the display format different from the normal display format is an item of the ticket information different from the current machine setting.

18. The image forming method according to claim 15, comprising:
displaying the function display for changing the machine setting in a position not overlapped with description of contents of a list of the stored jobs and contents of the ticket information of the stored job.

19. The image forming method according to claim 15, wherein the machine setting includes setting regarding paper.

20. The image forming method according to claim 19, comprising:
displaying a tray setting state as the contents of the current machine setting, the tray setting state at least including display of a paper size, a paper name, and basis weight, wherein a condition to determine difference in the setting further includes adjustment values accompanying with a profile of the paper.

21. The image forming method according to claim 19, comprising:
displaying, when the ticket information of the selected job includes setting which makes the output with contents of setting of a currently used tray impossible, information to distinguish whether the same tray is scheduled to be used by another stored job.
